(19) United States
(12) Patent Application Publication
(10) Pub. No.: US 2020/0258058 A1
(43) Pub. Date: Aug. 13, 2020

(54) METHOD AND APPARATUS FOR OPERATING A SANITARY INSTALLATION

(71) Applicant: Grohe AG, Hemer (DE)

(72) Inventors: Bert DEPIERE, Wakkerzeel (BE); Daniel RADERMACHER, Duesseldorf (DE)

(73) Assignee: Grohe AG, Hemer (DE)

(21) Appl. No.: 16/859,318

(22) Filed: Apr. 27, 2020

Related U.S. Application Data
(63) Continuation of application No. PCT/EP2018/077292, filed on Oct. 8, 2018.

(30) Foreign Application Priority Data
Oct. 25, 2017 (DE) 10 2017 124 922.2

(51) Int. Cl. G06Q 10/00; E03B 7/04; G01F 15/06

(52) U.S. Cl. CPC G06Q 10/20; G01F 15/063; E03B 7/04

(57) ABSTRACT

A method and apparatus for detecting users of a sanitary installation, with which at least one sanitary sensor system is associable. At least one use profile is detected for at least one user of the sanitary installation via the at least one sanitary sensor system in a first timeframe. The specified use profile is associated with at least one specified user in a database. The use profile of the sanitary installation is monitored by the at least one sanitary sensor system in a second timeframe. A specific use profile of at least one specified user is identified from the use profile of the sanitary installation, an individual use of at least one specified user is ascertained from the use profile of the sanitary installation, and/or an ascertained individual use of at least one specified user is stored in the database.

This nonprovisional application is a continuation of International Application No. PCT/EP2018/077292, which was filed on Oct. 8, 2018, and which claims priority to German Patent Application No. 10 2017 124 922.2, which was filed in Germany on Oct. 25, 2017, and which are both herein incorporated by reference.

### BACKGROUND OF THE INVENTION

### Field of the Invention

The present invention relates to a method for detecting users of a sanitary installation and an apparatus correspondingly set up for carrying out such a method.

### Description of the Background Art

Especially in complex sanitary installations that include a large number of users, it is challenging to maintain trouble-free operation in the long term and/or to be able to reliably estimate user water use. The type of users which are hooked up to a sanitary installation are increasingly varied and complex. In addition to faucets, sinks, toilets, showers and bathtubs or whirlpools, users that must also be considered are washing machines, beverage preparation installations, coffee machines, refrigerators, sprinkler installations, cooking appliances and the like. The issue of maintenance is amplified for larger units, such as hotel complexes, holiday complexes, factories, etc., because a larger number of users may be connected to the sanitary installation. Especially in such large sanitary installations, it is possible that in many cases the same type of users are connected in large numbers. Since the maintenance effort for such sanitary installations is very complex and/or malfunctions of the sanitary installation can lead to relatively long downtimes, for example because it may be unclear where there is a need for repair or maintenance, improvement of this predicament is desirable.

### SUMMARY OF THE INVENTION

It is therefore an object of the present invention to provide a method for detecting users of a sanitary installation and a correspondingly configured apparatus, which at least partially alleviates the problems described with reference to the prior art. In particular, methods and apparatuses are to be proposed which have a positive influence on analysis, maintenance measures and/or building management.

In an exemplary embodiment a method for detecting users of a sanitary installation which has at least one water pipe arrangement, by means of which water is supplied to a plurality of users and with which at least one sanitary sensor system is associable. The method comprises at least the following steps: detecting at least one use profile for at least one user of the sanitary installation by means of the at least one sanitary sensor system in a first timeframe; associating the specified use profile with at least one specified user in a database; monitoring the use profile of the sanitary installation by means of the at least one sanitary sensor system in a second timeframe, wherein at least one of the following processes is performed: identifying a specific use profile of at least one specified user from the use profile of the sanitary installation; ascertaining an individual use of at least one specified user from the use profile of the sanitary installation; and storing an ascertained individual use of at least one specified user in the database.

The water pipe arrangement can be formed with a pipeline system which, for example, comprises a central supply pipe and then a plurality of branched sub-pipe systems, each of which is fed to an individual user or a number of users. In particular, the water pipe arrangement may be associated with valves, pumps or the like, which allow for water flow through the water pipe arrangement in the predetermined manner. The users can be actuated manually, but it is also possible that they can be actuated electrically by means of a control unit. Preferably, each user occupies an outlet/connection of the water pipe arrangement.

It is possible that the water pipe arrangement is equipped with a single sanitary sensor system, but in many cases the use of several sanitary sensor systems at different locations in the water pipe arrangement is expedient. A sanitary sensor system is understood in particular to mean a measuring arrangement with which a status-parameter characteristic of the water in the water pipe arrangement can be ascertained. The sanitary sensor systems accordingly preferably interact (directly or indirectly) with the water in the water pipe arrangement. In particular, the sanitary sensor systems are set up to detect a water pressure, a change in water pressure, a water flow or the like. In addition, the sanitary sensor systems can (additionally) be set up, for example, to determine the temperature of the water in the water pipe arrangement.

In step a), in particular in a first timeframe, which can also be referred to as a learning phase, for example, a use profile is captured via the at least one sanitary sensor system or a sanitary sensor system specifically associated with an individual user. In particular, it is provided in this first timeframe that only a single user is activated and thus its use profile is captured by means of the (associated) sanitary sensor system. This process can be repeated for the same user and/or for other users of the same type in the sanitary installation. If needed, the use profile can be characterized on the basis of specific parameters, such as, for example, pressure over time, flow rate over time or the like.

The use profile captured in this way is thus specified for a particular, specified user. Step b) includes associating this specified use profile with the specified user in a database. Thus, based on the characteristic parameters for one or for a plurality or even for all users of the sanitary installation, a respectively specified use profile can be stored in the database. Thus, according to step b), a use profile that is characteristic for the regular operation of the respective user in the sanitary installation can be ascertained and/or stored for each specified user. These use profiles can also be called up at any time or can be compared with other use profiles.

According to step c), later, in particular after completion of the learning phase or in the regular operation of the sanitary installation, overall monitoring of the use history of the sanitary installation takes place. Again, the at least one sanitary sensor system is used, which carries out monitoring at least temporarily over this second timeframe. In particular, the sanitary sensor system can be arranged such that it monitors a use profile for the subsequent (optionally, several) users for a portion of the water pipe arrangement and/or that the use profile of the sanitary installation is monitored overall by means of a sanitary sensor system. Monitoring takes place in particular with regard to at least one, preferably all, of the following processes.

Process 1:

Here, the monitored use profile of the sanitary installation as a whole and/or of a part of the water pipe arrangement is used to identify, which specific use profile that can be determined from the database comprises at least one user. It can be recognized from the monitored use profile of the sanitary installation as to which specific use profile of a specified user or several specified users has created said profile. From the (overall) use profile of the sanitary installation it is therefore possible to draw conclusions about individual specific use profiles of specified users.

Process 2:

Due to the known specified user profiles for each or for individual specified users of the water pipe arrangement or the sanitary installation, In particular on the basis of process 1 the individual use of the at least one specified user can be ascertained over a predetermined timeframe. This means that the entire use profile of the sanitary installation can be analyzed to the extent that the overall profile can be associated with each or with a plurality of specified users. This makes it possible to draw conclusions about the individual use of a specified user from the use of the sanitary installation.

Process 3:

In particular on the basis of processes 1 and/or 2, the ascertained individual use can be stored over a specific timeframe and/or, where appropriate, stored in a cumulative manner in the database. In particular, this process can result in continuous updating of the individual use in the database.

Step a) may comprise ascertaining at least one of the following use parameters by means of the at least one sanitary sensor system: flow rate, flow time, change in flow rate, pressure in the water pipe arrangement, time and frequency of use. The use parameters listed here can be used individually and/or in combination with one another to describe the use profile or can be stored as such in the database. Where appropriate, the sanitary sensor systems can also include a temperature sensor in order to be able to more precisely evaluate temperature-dependent use parameters.

For a majority or for all users of the sanitary installation, step a) can take place in such a way that only their individual use profile is captured and in step b), this is associated in a database as a specified use profile with the respective, specified user. It is possible that a plurality of identical and/or different users are operated at the same time in the first timeframe, in which case the individual, respectively associable specified user profile is detected by means of one or more sanitary sensor systems for each user or each same type of user and is then stored in the database for the latter. In this way, the learning phase can be reduced, especially in large sanitary installations. There is also the possibility that with a large number of identical users, step a) is only specified for a single user and is then stored in the database as a reference for all identical users.

The method can be designed such that, with respect to at least one user of the sanitary installation, activity information is provided by a monitoring sensor system, which is taken into account at least in step a) or b). A monitoring sensor system is characterized in particular by the fact that it is not a sanitary sensor system, that is to say, in particular it does not indirectly or directly capture the use parameters flow rate, flow time, flow rate change, pressure in the water pipe arrangement, time and frequency of use. The monitoring sensor system can be set up to ascertain the operation of a user, for example based on the presence of a user, a switch setting of the user and/or a specific control command to a control unit. The activity information includes in particular the information as to whether a user is active, i.e. is currently using water, or not. The activity information can be used in particular to specify the actual user. The activity information can be a basic requirement or a verification for step a) and/or step b). It is possible that such activity information is also used for verification as part of step c). The monitoring sensor system may be arranged to capture a vibration, a noise, light intensity, humidity, a movement of objects/persons, an electric signal, a switch setting, etc.

At least one use profile for at least one user of the sanitary installation or the use profile of the sanitary installation can be arranged chronologically. In particular, the use profile of the user and/or the use profile of the (entire) sanitary installation (or the corresponding use parameters) can be arranged chronologically, so that a use profile, in particular with respect to a day, a week, a month, a year, can be tracked (and compared with presence, leave absence, etc.).

The individual use of a specified user ascertained in step c) can be compared with a provided, typical individual use and, if necessary, at least one use information is provided. The typical individual use relates in particular to the use profile that the specified user usually has, i.e., corresponding to its operating conditions and/or normal user behavior. The typical individual use can be provided by the user's manufacturer. The typical individual use can also be ascertained and specified on the basis of step a), in particular insofar as step a) was carried out after a user has been newly installed on the sanitary installation. The actual or recently ascertained individual use can therefore be compared with the typical individual use. Deviations between individual use and typical individual use can indicate wear and tear, incorrect operation or a need for maintenance. It is possible that malfunctions can be recognized or predicted from the comparison of an individual use and a typical individual use. If necessary, the typical individual use can also be adjusted using operating hours or service life in order to take aging behavior into account. Based on the comparison, in particular if an irregularity or insufficient agreement between individual use and typical individual use is determined, use information can be provided. The use information can, in particular, inform a user of a problem with regard to the specified user or directly initiate maintenance, repair or fault elimination.

According to a further aspect, an apparatus for operating a sanitary installation is proposed. The apparatus comprises at least one water pipe arrangement, by means of which water is supplied to a plurality of users and with which at least one sanitary sensor system is associable, as well as at least one computing unit which is connected to the at least one sanitary sensor system in a data-conducting manner, wherein the apparatus is set up to carry out a method presented here.

The above explanations of the method also apply to the apparatus described here, and vice versa.

It is preferred that a plurality of sanitary sensor systems is provided. It is possible, that all sanitary sensor systems are connected to a single computing unit, wherein this can be done wired or wirelessly (via radio, Bluetooth, Wi-Fi, mobile, via app, via website, etc.). The computing unit can be positioned in the immediate vicinity of the sanitary installation, but this is not required. The computing unit or at least one computing unit can be part of a cloud. The computing unit can comprise a data processing program, which is provided on the computing unit and which can execute, support or initiate at least one of the method steps described here.

The at least one computing unit can be connectable to a database and a time machine. The at least one computing unit can be permanently or temporarily connected to a database in a data-conducting manner and, if necessary, write data to or retrieve data from the database. Using the time machine, historical data, current data and/or time profiles can be extracted from the database or parameters relating to the use profile can be stored in the database under real times. The time machine can also be set up to compare historical data with current data.

The at least one computing unit can be connected to a mobile display device for use information in a data-conducting manner. This data-conducting connection is, in particular, at least partially wireless. The mobile display device can in particular be a telephone, a tablet, a laptop or the like.

The at least one computing unit can be connectable to at least one monitoring sensor system or to the at least one user of the sanitary installation in a data-conducting manner. The computing unit can be set up in such a way that it interacts with an alarm system and/or an M2M (machine-to-machine) communication interface. This can be done wired and/or wirelessly. The monitoring sensor system can have its own control center with which the computing unit interacts. The user can have an integrated control unit with which the computing unit interacts.

By capturing use parameters (e.g., the time of water withdrawal, the duration of water withdrawal, the sequences of different subsequent water flows, the maximum flow rate of the water, the minimum flow rate of the water, the number of withdrawals per day, the integral of the water withdrawals) and by establishing a building-specific algorithm, if applicable, it can be reliably identified as to which users are actually (jointly) responsible for the use of water. For example, a washing machine has a different characteristic use profile than the withdrawal to fill a tub.

The identification of specific use profiles from the use profile of the sanitary installation enables a simple use analysis for the respective user. For example, maintenance intervals can be adhered to, resources reordered, or operating errors identified. It is also possible to see at which point water savings are possible, for example by replacing a user with high water use with a corresponding user with lower water use. This information can be provided directly and/or indirectly to the user or to building management, so that appropriate maintenance measures, repair measures or replacement measures can be initiated. If necessary, the ascertained use profiles can also be compared with those in other sanitary installations, so that corresponding use information or maintenance requirements, repair requirements or remodeling measures can be identified at the sanitary installation itself. If necessary, it can also be achieved that the occupant of the house and a building management system are provided real-time or current information about the use and/or the number of users who are active. Based on this, estimates of future use, measures to avoid overloading the sanitary installations and/or adjustments in the operation of the individual users can be made.

The invention is illustrated using the following examples. In particular, the apparatus can be equipped with a sanitary sensor system which detects the flow, the time of day, the time taken for use, the change in flow and the pressure. The data or use parameters can be associated with a building or a building complex and/or to the residents therein and made available. This data can also be analyzed in a computing unit or a cloud and then stored in the manner of a profile. The use profiles may, for example, be described according to the type of sampling event, in particular its number and/or as an integral function, i.e., as a change in the use parameters over time. The data determined in this way can be made available to a database, where it can be analyzed and associated with specific users and/or sanitary installations and/or their operators. In particular, such profiles can be created and stored for the respective users of a specified sanitary installation. By identifying such profiles, use can be calculated and possibly estimated or shown as a total over a specific timeframe. Based on these situations, information can be provided which in particular supports maintenance and/or reduces water use.

The learning phase can also be initiated independently by the sanitary installation. If, for example, the monitoring sensor system detects that a certain area of the sanitary installation is not currently used and/or no user is currently planning to use it, step a) and/or step b) may be initiated independently, in particular if the user is connected to the drainage system by a drain. In this case, the sanitary installation can be operated such that step a) is carried out and so that the result for this specific individual use analysis is then stored in the database. If necessary, the algorithm can then also be checked, which, when the installation is operated again, then identifies the previously specified user as the cause of the repeated water withdrawal.

The concept proposed here can be implemented in part or in full using a method carried out on a computer, comprising steps a), b) and c).

Furthermore, a system for data processing is proposed, which comprises a computing unit or a processor which is adapted and/or configured in such a way that it partially or completely performs steps a), b) and c) of the method.

A computer program or a computer program product is also proposed, comprising commands which cause the computer to execute a program that partially or completely performs steps a), b) and c) of the method.

A computer-readable storage medium is also proposed, comprising commands which, when executed by a computer, prompt the computer to partially or completely carry out steps a), b) and c) of the method.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a sanitary installation 1 in a property,

FIG. 2 is a diagram to illustrate steps of the invention, and

FIG. 3 is a diagram to a illustrate further step.

### DETAILED DESCRIPTION

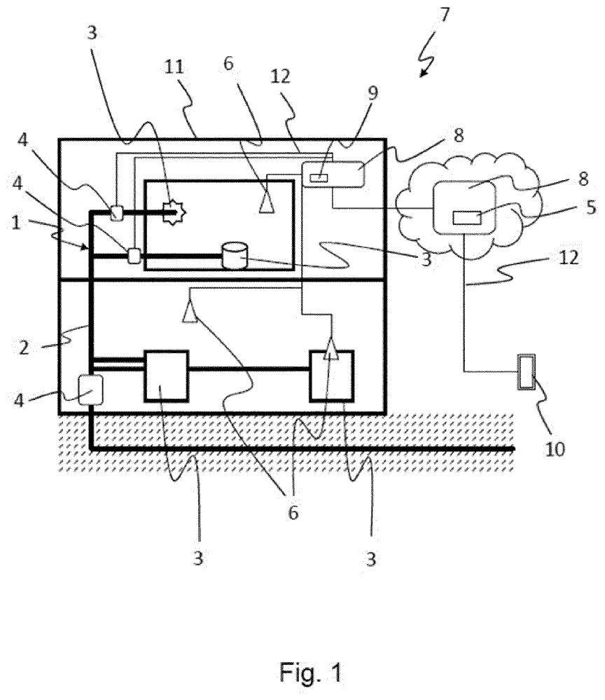

FIG. 1 shows an apparatus 7 for operating a sanitary installation 1. The apparatus 7 is set up for detecting users 3, which can be associated with a water pipe arrangement 2. By means of the water pipe arrangement 2, water is widely supplied to each of the users. FIG. 1 shows an example of the situation of a property 11, wherein in the basement area, for example, two washing machines are provided as users 3. These are supplied with water via the water pipe arrangement 2. A bathroom is shown as an example in the upper area of the property 11, with a shower and a toilet being shown as users 3. The water pipe arrangement 2 also has a plurality of sanitary sensor systems 4, which are in particular set up to determine at least one of the use parameters flow rate, flow time, flow rate change, pressure in the water pipe arrangement. It is possible that a sanitary sensor system is associated with an individual user, but it is also possible that it applies to multiple users.

Furthermore, a computing unit 8 is provided, which is positioned in the property 11. This is temporarily or permanently connected to the sanitary sensor system 4 via (wired and/or wireless) data-conducting connections 12 and/or via a monitoring sensor system 6. The monitoring sensor system 6 can be disposed in the area of the user, in the area of the property 11 or its surroundings, in the manner of a motion detector, a light sensor or a switch in the area of the user. The computing unit 8 can store and/or analyze the use parameters or activity information thus obtained, possibly paired with the data of an integral time machine 9. Where appropriate, it is also possible that the local part of the computing unit forwards the data (optionally via a router) to a further computing unit 8, which is part of a cloud, for example. The computing unit can be connected to a database 5 in order to store or analyze profiles or use profiles and/or users of a specified sanitary installation there. The results obtained in this way can be transmitted back to the property 11 and/or possibly also to a (mobile) display device 10.

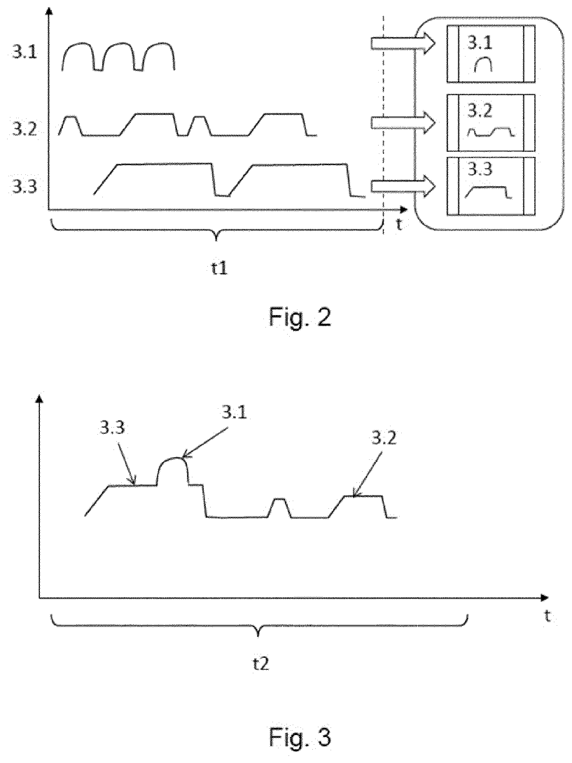

By way of example, FIG. 2 illustrates steps a) and b) for three different users 3.1, 3.2 and 3.3. In this case, a characteristic operation of a user of the sanitary installation is carried out, possibly repeated several times. The characteristic or averaged use profile is thus specified and associated with a specified user in the database 5. FIG. 2 shows how in the first time timeframe t1 multiple users are analyzed or operated at the same time.

In accordance with step c), FIG. 3 then illustrates how the use profile of the sanitary installation is monitored over a second timeframe t2 and the characteristic individual use profiles of the specified users are recognizable. For example, in the area shown on the left, the typical use profile for user 3.3 is recognized, which is then additionally superimposed by a use profile of the specified user 3.1, with the typical specified use profile of the user 3.2 then being added after a longer pause. This way, individual use information can be extracted again and associated with the respective user. The accumulation makes it possible to draw conclusions about the total use for each individual user, i.e., said use can also be forecast for future timeframes. By comparison, it is also possible to identify operating errors or the need for maintenance. The corresponding use information can be provided to the user or to a building management system in a timely manner, possibly prior to potential damage or downtime.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for detecting users of a sanitary installation, which has at least one water pipe arrangement via which water is supplied to a plurality of users, and with which at least one sanitary sensor system is associated, the method comprising:
a) detecting at least one use profile for at least one user of the sanitary installation via the at least one sanitary sensor system in a first timeframe;
b) associating the specified use profile with at least one specified user in a database; and
c) monitoring the use profile of the sanitary installation via the at least one sanitary sensor system in a second timeframe, wherein at least one of the following processes is performed:
identifying a specific use profile of at least one specified user from the use profile of the sanitary installation;
ascertaining an individual use of at least one specified user from the use profile of the sanitary installation; and/or
storing an ascertained individual use of at least one specified user in the database.

2. The method according to claim 1, wherein step a) further comprises ascertaining at least one of the following use parameters via the at least one sanitary sensor system:
flow rate, flow time, flow rate change, pressure in the water pipe arrangement, time or frequency of use.

3. The method according to claim 1, wherein step a) is carried out for a plurality or for all users of the sanitary installation such that only their individual use profile is detected and in step b), the latter is associated in each case in a database as a specified use profile for the respective, specified user.

4. The method according to claim 1, wherein an activity information is provided by a monitoring sensor system for at least one user of the sanitary installation, which is taken into account at least in step a) or b).

5. The method according to claim 1, wherein at least one use profile for at least one user of the sanitary installation r the use profile of the sanitary installation is chronologically arranged.

6. The method according to claim 1, wherein the individual use of a specified user ascertained in step c) is compared with a provided, typical individual use and, if necessary, at least one use information is provided.

7. An apparatus for operating a sanitary installation, the apparatus comprising:
at least one water pipe arrangement via which water is supplied to a plurality of users and with which at least one sanitary sensor system is associated; and
at least one computing unit, which is connected in a data-conducting manner to the at least one sanitary sensor system,
wherein the apparatus is set up to carry out the method according to claim 1.

8. The apparatus according to claim 7, wherein the at least one computing unit is connectable in a data-conducting manner with a database and a time machine.

9. The apparatus according to claim 7, wherein the at least one computing unit is connectable in a data-conducting manner with a mobile display device for use information.

10. The apparatus according to claim 7, wherein the at least one computing unit is connectable in a data-conducting manner with at least one monitoring sensor system or at least one user of the sanitary installation.
